(19) United States
(12) Patent Application Publication
(10) Pub. No.: US 2007/0244729 A1
(43) Pub. Date: Oct. 18, 2007

(54) SYSTEM AND METHOD FOR EASY ACCESS TO SCUBA TRAINING AND CERTIFICATION

(75) Inventors: Charles Whiteman, Ft. Lauderdale, FL (US); Kevin Senecal, Ft. Lauderdale, FL (US)

Correspondence Address: Dickinson Wright PLLC, 38525 Woodward Avenue, Suite 2000, Bloomfield Hills, MI, 48304, US

(73) Assignee: Holiday Diver, Inc., Dania Beach, FL (US)

(21) Appl. No.: 11/379,163

(22) Filed: Apr. 18, 2006

(51) Int. Cl. G06Q 10/00

(52) U.S. Cl. 705/5

(57) ABSTRACT

A system and method for exposing more of the population to SCUBA by creating an online SCUBA instruction course. Forming marketing partnerships with a plurality of travel entities such that the plurality of travel entities distribute links to the online SCUBA instructor course. Signing up students for the online SCUBA course and seemlessly booking their in water certification through the plurality of travel entities.

### TECHNICAL FIELD

The present invention relates generally to a system and method for providing access to an online SCUBA instruction course and associated SCUBA related travel through an integrated delivery platform in an effort to allow individuals to be more easily certified for SCUBA diving.

### BACKGROUND

Reducing consumer costs is a constant goal for current systems that have been developed for the general purpose of planning and arranging travel, i.e. travel arrangement systems. In particular, travel arrangement systems have involved the use of computer databases combined with software to find and determine the lowest fares available for airlines, resort locations, and various other travel accommodations and activities.

There have also been many systems designed to aid, in a limited way, in the planning and execution of travel arrangements. For many years, travel arrangements have been made for consumers by travel agencies having standalone systems, with electronic or simple telephonic links to travel providers such as airlines, passenger trains, buses, car rental agencies and the like, as well as links to travel related service providers, such as hotels, restaurants, entertainment facilities, etc. In effect, the consumers have relied on travel agencies to locate the best available fares and rates.

In recent years, consumers have gained greater direct access to information related to travel service providers via the Internet. Such information includes airline schedules, flight availability, hotel locations, and entertainment location information. In order to reserve a seat on a plane or a hotel room, the individual must still make separate contact with a particular provider and make the reservation based upon the provider's distinct reservation system. This can often be a time consuming process, whereby the best possible rate for travel and travel-related activities may not be obtained. In other words, although inexpensive fares may be available, the consumer must go through a considerable search process in order to gather information regarding travel and travel-related activities.

This search process may include bidding on websites such as priceline.com®, wherein the consumer attempts to bid for the lowest price acceptable to a service provider. This process, however, requires the consumer to guess at what the current low rate is and may thus not necessarily end up reducing the cost to the consumer.

The disadvantages associated with typical current methods utilized by consumers for making travel arrangements have made it apparent that a new technique for arranging travel is needed. The new technique should rapidly and efficiently locate the travel arrangements that are least expensive for the consumers. The new technique should also minimize the time consumers spend searching for cheapest fares. The present invention is directed to these ends. The present concept also has specific application in the filed of SCUBA and SCUBA-related travel.

SCUBA is a travel-oriented activity and thus methods to make inexpensive SCUBA-related travel are extremely desirable. The best places to participate in the sport are in tropical warm water destinations such as South Florida, the Caribbean, Hawaii, and the South Pacific. However, SCUBA is not generally marketed or promoted by any entities in the travel industry. Currently, most marketing for the industry is either grass roots or focused on current participants. The majority of print media advertising for SCUBA is done in industry magazines that are sent to certified divers, i.e. those already involved in SCUBA.

Thus, despite efforts to make SCUBA-related travel and SCUBA certification easier and more accessible, the SCUBA market has historically reached only a small percentage of people interested or potentially interested in SCUBA travel and/or certification. It is estimated that less than five (5) million certified divers exist today. However, current research (from a project funded by the Dive Equipment Marketing Association (DEMA)) indicates that about twenty six percent (26%) of Americans age 16 and older are interested in trying SCUBA diving. According to the U.S. Bureau of Labor and Statistics there are approximately 220 million Americans age 16 and older. Taking 26% of this total yields a potential dive market of 57 million. Thus, retailers and direct marketers of SCUBA equipment are reaching only a very small percentage of the potential dive market.

Currently, mechanisms do not exist for effectively introducing SCUBA to this much larger potential market. Further, even if mechanisms existed to reach this potential market, ready means do not currently exist to allow people in this potential market to be easily trained in and certified for SCUBA diving. Similarly, inexpensive ways to allow for potential divers to complete their certification do not exist.

For example, while many non-divers are interested in diving, a variety of factors typically prevent or discourage these individuals from learning to dive. These include that these people do not live near a place where they can dive or do not have the time to dive. Other reasons include that they do not vacation at a destination where they can dive, do not know where to go to learn to dive, and/or do not know anyone else who dives. Additionally, many non-divers believe it is too expensive to learn how to dive. These factors all limit the expansion of the SCUBA market.

Currently, in the U.S. there are about four major recreational SCUBA training agencies for non-divers to learn how to dive, namely PADI, NAUI, SSI, and SDI. These agencies provide teaching standards and materials to dive instructors who, in turn, train new divers. The primary retail marketing strategy for these training agencies consists of selling themselves to local dive shops and using this distribution network to promote and sell their respective training materials. However, this distribution network is extremely limited as, according to a DEMA certification survey at www.dema.org, these four agencies have issued less than fifty thousand new dive certifications per year for the period from 2000 to 2004.

There is thus a need to develop a method and system for exposing SCUBA to potential new divers. There is also a need to develop a mechanism to expose non-divers to the SCUBA market and make it easier for them to become certified.

### SUMMARY OF THE INVENTION

It is therefore one advantage of the present invention to provide a method and system for making SCUBA training and certification more readily accessible to interested persons that currently do not dive.

It is another advantage of the present invention to provide a method and system that increases the number of active SCUBA divers and thereby increases the SCUBA market.

It is still another advantage of the present invention to provide a method and system that integrates the market channels for SCUBA instruction, SCUBA gear, and SCUBA-related travel for more seamless and efficient delivery.

It is yet another advantage of the present invention to provide a method and system for allowing a SCUBA retailer to partner with entities in the travel industry to promote new participation in SCUBA diving and providing corresponding revenue to such entities for its part in attracting new divers to the SCUBA market.

It is a related advantage of the present invention to provide a method and system for standardizing and streamlining how consumers learn to SCUBA dive by integrating an e-learning platform with an online travel booking engine and e-commerce platform.

It is another related advantage of the present invention to provide a method and system that develops mutually beneficial marketing partnership, such as with airlines, cruise lines, resorts, rental cars, and a network of affiliated SCUBA instructors that all participate in this online platform.

It is still another related advantage of the present invention to provide a method and system that allows for the creation of a virtual sales force, which directs students and potential students to SCUBA instructors who participate in the online platform and also provides the necessary equipment and services to those students in order to provide proper SCUBA instruction.

In accordance with one aspect of the present invention, a system and method for arranging travel includes a partner, such as an airline, that provides customers free or discounted access to an online SCUBA instruction course. This course includes content featuring the marketing partner logo and branding. During the SCUBA course, the customer books a trip for completing SCUBA certification in select destinations serviced by the partner airline, which is the only airline offered as part of this travel package. Near the completion of the course, the customer books in-water work (pool training and open water training) for completing the course.

The present invention overcomes prior encountered marketing problems by creating a win-win relationship with the airlines as well as other service providers, including car rental companies, hotels, resorts, etc. By providing the airlines or other service providers with a course that they can give away free (or allow free or discounted access) to customers and potential customers, the airlines or other service providers gain the following benefits: a value-added offer used to build customer loyalty; the ability to deliver service provider-specific brand messages throughout the online training; a captive market at the end of the course with the travel reservation process integrated into the training platform; the fact that SCUBA divers must travel to pursue their sport raises the prospect of future leisure travel revenue from newly certified divers; and a tool to appeal to a large, currently existing market.

Additional advantages and features of the present invention will become apparent from the description that follows and may be realized by the instrumentalities and combinations particularly pointed out in the appending claims, taken in conjunction with the accompanying drawings.

### BRIEF DESCRIPTION OF THE DRAWINGS

For a more complete understanding of the invention, there will now be described some embodiments thereof, given by way of example, reference being made to the accompanying drawings, in which:

FIG. 1 is a block diagram schematically illustrating the operation of a system and method for delivering online SCUBA instruction as part of an integrated platform in order to expose SCUBA to more potential customers and increase the number of SCUBA divers in accordance with one embodiment of the present invention;

FIG. 2 is a block diagram schematically illustrating the online SCUBA instruction course and some of its features in accordance with one embodiment of the present invention;

FIG. 3 is a block diagram schematically illustrating a system and method for providing an integrated online platform for providing increased SCUBA participation and certification in accordance with one embodiment of the present invention;

FIG. 4 is a block diagram schematically illustrating a system and method for developing marketing partnerships with other travel entities in accordance with one embodiment of the present invention;

FIG. 5 is a block diagram schematically illustrating a system and method for creating a virtual sales force of SCUBA instructors in accordance with one embodiment of the present invention;

FIG. 6 is a block diagram schematically illustrating the collective reverse auction feature in accordance with one embodiment of the present invention;

FIG. 7 is a block diagram schematically illustrating the operation of the method and system in accordance with one embodiment of the present invention;

FIG. 8 is a schematic illustration of the components of the system and method for delivering online SCUBA instruction as part of an integrated platform shown in FIG. 1.

### DETAILED DESCRIPTION OF THE PREFERRED EMBODIMENT

The present invention is illustrated with respect to a system and method for exposing a large segment of the population to SCUBA by distributing an online SCUBA instruction course and integrating it with the delivery of other online services. Thereafter, these integrated services allow for the customers or students to easily make travel arrangements inexpensively.

In accordance with one embodiment of the present invention, a system and method for providing an online platform, which integrates the delivery of SCUBA instruction with online travel booking and online shopping services, is provided. Depending upon how the customer arrives at the platform, the content of the online course as well as the travel and merchandise options presented in the booking and e-commerce can be customized, as discussed in more detail below.

The disclosed system and method is intended to allow easier access to an online SCUBA instruction course for those who are not currently involved in SCUBA diving, but have interest in doing so. The disclosed system and method provides for an easier way to set up a student's open water dive in order to fulfill all requirements for SCUBA certification. The disclosed method and system also provides mechanism such that the arrangements for SCUBA travel as well as for the open dive can be easily made and can be made at a decreased expense in connection with the same platform as the online SCUBA course.

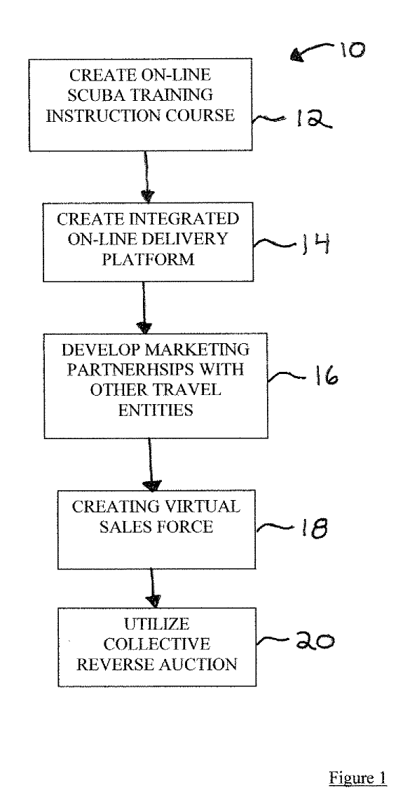

As shown in FIG. 1, the system and method consists of multiple components or aspects 10, including an online SCUBA training instruction course 12, an integrated online platform 14 for delivery of the online SCUBA training instruction course 12, a plurality of marketing partnerships with various travel entities 16 that allow for increased distribution of the online SCUBA training instruction course 12, a virtual sales force of qualified SCUBA instructors 18 that are affiliated with the online platform 14 to complete the training and certify divers, and a collective reverse auction 20 to provide travel to its customers or students at decreased price. While the embodiments described herein are exemplarily discussed with respect to scuba, it will be understood that the system and method can be applied to and utilized for other water sports, including snorkeling. Additionally, it will also be understood that the system 10 can include more or less components than those described above.

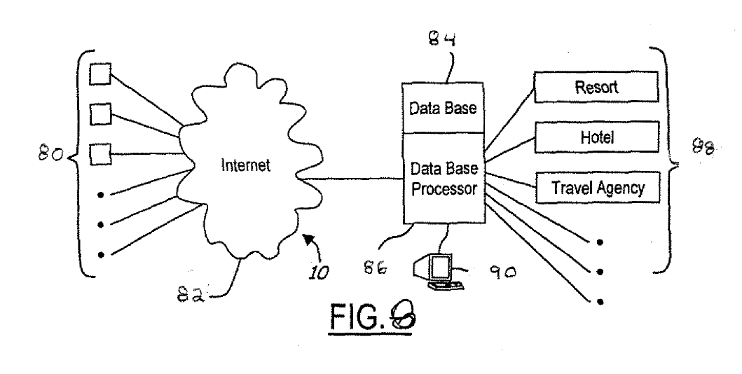

FIG. 8 schematically illustrates the integrated system 10, in accordance with one embodiment of the present invention. As shown, the system 10 includes a plurality of consumers or students 80, an information medium 82 (Internet), a database 84, a database processor 86, a plurality of service providers 88 or travel partners, and a service coordinator or proprietor 90.

In operation, the plurality of consumers or students 80 communicate through the information transfer medium or Internet 82 to send and receive information to and from the database 84 and the proprietor 90. As will be understood, the information transfer medium 82 is coupled to the database processor 86, which is coupled to the database 84. The database 84 and the database processor 86 receive information from the plurality of service providers 88 as well as from the plurality of affiliated instructors, as discussed below.

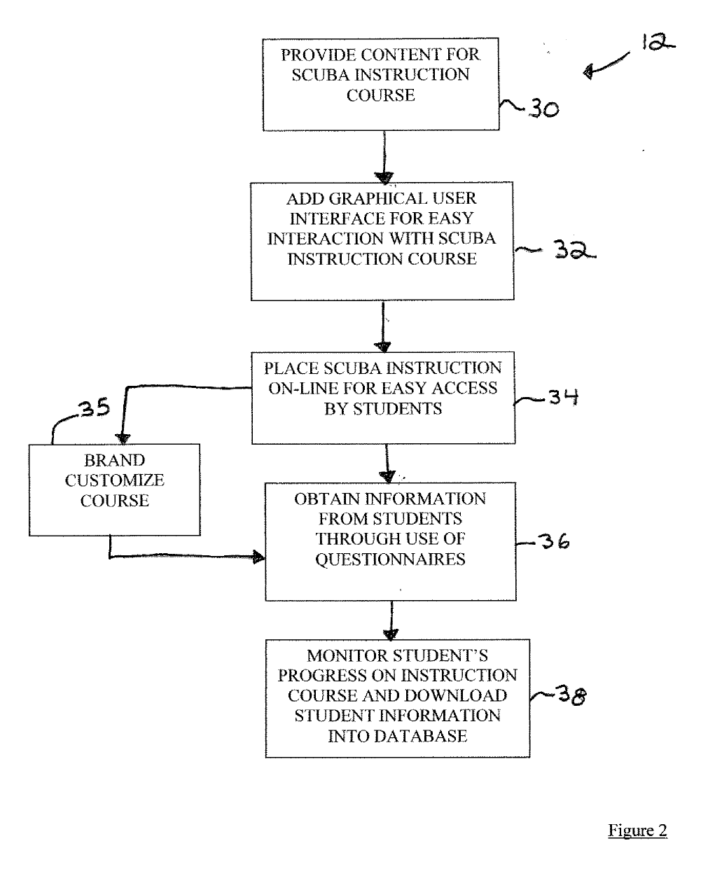

The first component of the disclosed system and method 10 is the online SCUBA training instruction course 12. The SCUBA training instruction course 12 is generally illustrated in the block diagram of FIG. 2. As shown, according to one embodiment of the present invention, the content for the SCUBA instruction course 12 is provided or created, as shown generally by reference number 30. The content is created to teach the students what they need to know in order to SCUBA dive and importantly how to SCUBA dive safely as will be understood by one of ordinary skill in the art. In fact, the online SCUBA instruction course 12 preferably has an extensive academic curriculum to best teach students. In one embodiment, the SCUBA training instruction course 12 consists of conventional online SCUBA training software, such as is available from www.SCUBA-training.net. The purpose of the course content is to train and prepare the student for the in water dives and certification.

After the course instruction content is provided, in accordance with one embodiment, a user-friendly graphical user interface is added to the software, as is generally indicated by reference number 32. This graphical user interface 32 helps make the training more enjoyable and exciting to the students. Thus, the SCUBA course 12 is both informative and enjoyable. In addition to text teaching, the preferred SCUBA instruction course 12 includes videos that assist in teaching the students the necessary subject matter. The online SCUBA training course 12 is fully interactive and allows for training of students using a multi-media system as will be understood by one of ordinary skill in the art. Once the software program containing the course content and the graphics has been completed, the SCUBA instruction course 12 is placed online at a web site on the information transfer medium 82 such that it is easily accessible, as generally indicated by reference number 34, and as will be easily understood by one of ordinary skill. The online SCUBA instruction course 12 is preferably given away to customers or potential customers at no charge or at a reduced charge in a manner discussed in more detail below. Alternatively, the SCUBA training instruction course 12 can be transmitted to customers and/or potential customers in a hard copy form, such as DVD or the like.

Moreover, as discussed in more detail below, the SCUBA training instruction course 12 can be brand customized, as generally indicated by reference number 35. In this instance, the visual content of the course is automatically modified depending upon how the student comes to take the SCUBA instruction course 12. In other words, if the referring entity is a SCUBA retailer, only their equipment would be illustrated and referred to in the SCUBA instruction course 12. Similarly, if the referring entity is an airline or rental car company for example, their logo or trademark is displayed on the screen as the student advances through the course 12, which provides significant brand exposure to the referring entity. By way of further example, any airplanes illustrated in the background of the course 12 would be branded with the referring partner's logo.

As generally indicated by reference number 36, the online SCUBA instruction course 12, includes a series of questionnaires that gather and obtain information from the students. This information includes general background information on the students, such as name, age, gender, address and the like for purposes of record keeping. This information is stored on the database 84. Additionally, other information that is gathered includes profile information about the students to better match them with affiliated instructors for their open dive certification as well as to identify potential dive locations for which to conduct their certification. This information is also stored on the database 84. Further, the questionnaires also seek to identify any limiting information regarding the students that may affect their ability to dive. The online SCUBA instruction course 12 preferably communicates with a computer 90, such as generally indicated by reference number 38, that is run by the proprietor of the website on which the SCUBA course 12 is accessible. This allows the database 84 associated with the computer 90 to store the information gathered from each of the students for further use. Additionally, as a result of this communication, the proprietor of the website housing the online SCUBA instruction course 12 can also monitor the progress of the students throughout the SCUBA instruction course 12.

The online SCUBA training course 12 provides distinct advantages over other available training courses. Initially, other training courses are typically conducted in classrooms or the like. Therefore, they operate at increased overhead because they require instructors. The disclosed online SCUBA training course 12 allows for the training of professionals who have busy schedules who would not otherwise be able to attend an evening class. Further, it allows students to learn at their own pace, on their own time, and at their own pace. Moreover, a beginning diver could start learning immediately rather than waiting, such as a week or a month, until the next class begins. Additionally, the disclosed online course 12 allows students to spend more time in the water rather than in the classroom. All these advantages provide significant benefits over non online courses.

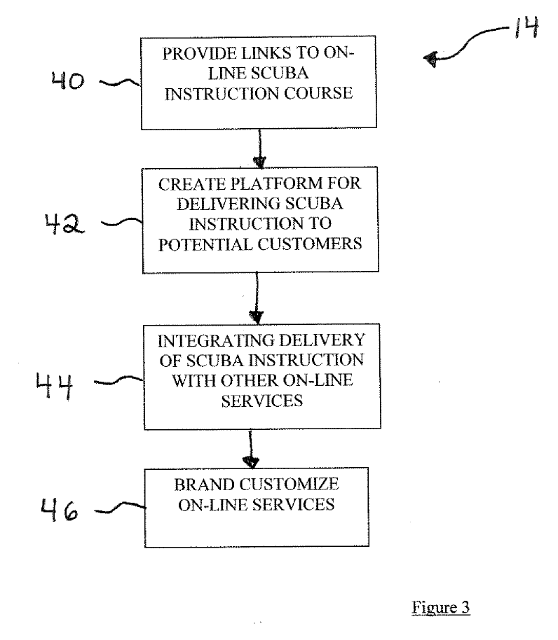

Referring now to FIG. 3, which illustrates a system and method for creating an integrated online delivery platform 14 for integrating delivery of the online SCUBA training course 12 with other on-line services potential students. As generally identified by reference number 40, a link to the website containing the online SCUBA instruction course 12 is provided or made available for distribution. Next, as generally identified by reference number 42, a platform is created to allow delivery of the SCUBA instruction course, along with the services to potential customers.

Currently, the SCUBA market has excessive fragmentation within and across the areas of instruction, gear and travel. The amount of money spent on these areas is split among tens of thousands of dive instructions, about a thousand dive shops, and thousands of travel agencies. It would therefore be extremely beneficial to integrate the delivery of these services (instructor, gear and travel) and market them to the large potential market for fewer companies to gather a larger amount of market share for their services. In accordance with the present invention, it is an advantage to market these services within the context of a tropical adventure vacation and deliver these services seamlessly and efficiently.

In one embodiment, the platform includes online services, such as online travel booking and online shopping services, which are integrated with the online SCUBA course. An example of an online travel reservation engine that the present system can be integrated with is www.reslogic.com. Once the platform is created, the links are integrated with other online services such that when a customer or potential customer accesses these online services the SCUBA instruction course 12 is made available thereto, as generally indicated by reference number 44. In operation, when these services are delivered to potential customers, they are provided a link that provides them access to the SCUBA training course 12 at no cost or at significantly reduced cost. Further, as discussed below, the sale of SCUBA equipment to students is also preferably integrated into the platform such that to the extent they require SCUBA equipment the only equipment offered through the system 10 is that sold by the proprietor 90.

Additionally, depending upon the source of the student who takes the course 12, the content of the online course 12 can be customized, as generally identified by reference number 35 in FIG. 2. Similarly, the content of the online services, such as travel booking and shopping services, can be customized, as generally indicated by reference number 46. For example, in one embodiment, if a student or visitor clicks through from an airline marketing email, such as from Spirit Airlines, the online SCUBA instruction course 12 would be co-banded with Spirit Airlines. In this scenario, Spirit Airlines would be the only provider of flights for the customer or student when they reach the point of the course where they need to book their dive vacation to complete their certification. Further, it is known that an average new diver typically spends up to a thousand dollars on SCUBA equipment in becoming certified. Thus, integrating these equipment sales together with the online instruction course 12 provides further revenue to the proprietor of the website of the website or SCUBA equipment partner to the extent the proprietor does not sell SCUBA equipment.

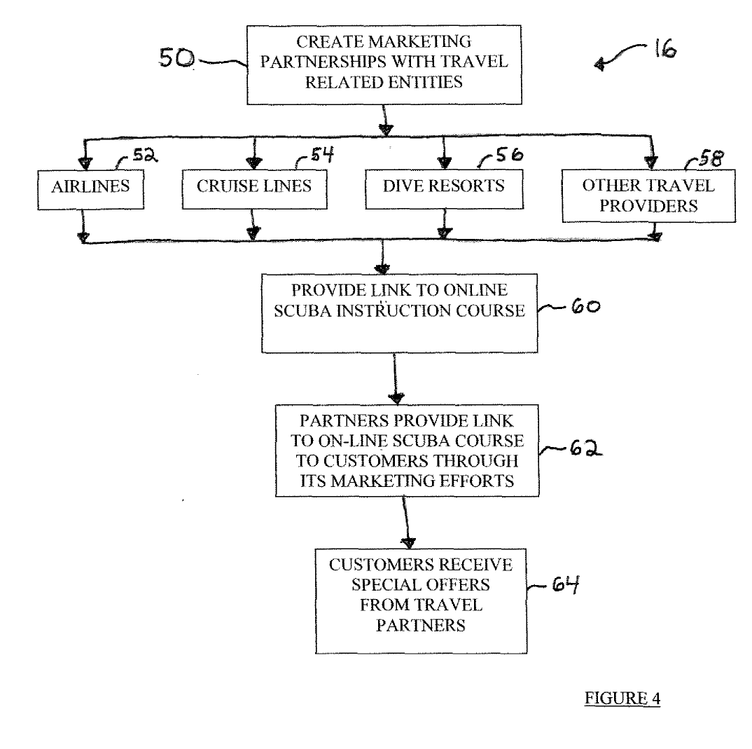

FIG. 4 schematically illustrates a block diagram of a system and method for developing marketing partnerships, as generally indicated by reference number 16. It is known that travel and diving are closely linked for a large number of SCUBA divers. Accordingly, in accordance with one embodiment, the proprietor of the online SCUBA instruction course 12 forges marketing partnerships with large travel operators or entities, as generally indicated by reference number 50. These marketing partners include, but are not limited to airlines, cruise lines, dive resorts and other travel providers, such as rental car companies, as respectively indicated by reference numbers 52, 54, 56, and 58. Alternatively, the proprietor of the website can advertise in travel media to promote SCUBA as a safe and fun way to spend one's vacation time.

Once the partnerships are formed, each of these entities will be provided with the link to the online SCUBA instruction course 12, as generally indicated by reference number 60. The travel partners can then promote the course through marketing special offers in its own marketing to their customers by offering free (or discounted) online SCUBA instruction course 12. In one embodiment, the partners include a link to the online SCUBA instruction course 12 in an outbound marketing e-mail, as generally indicated by reference number 62. Obviously, the travel partners can distribute the link to potential customers in a variety of other suitable ways.

Throughout the online SCUBA course 12, customers or students will be presented with special offers, such as vacation offers from the travel partners, as generally indicated by reference number 64. For example, a partner airline that provides customers free or discounted access to the online SCUBA course 12 will have the content of the online SCUBA course 12 feature its airline logo and branding if the student accesses the course as a result of the partner's marketing efforts. Throughout the SCUBA course 12, the customer or student may book a trip to complete their SCUBA certification in select destinations serviced by the partner airline. In this instance, the partner airline is the only airline offered as part of this travel package due to the integration of the reservation process (including travel partners therein) directly into the training platform. Near the completion of the course 12, the customer may be required to book their in-water work (pool training and open water training) in order to complete the course. Thus, to the extent the customer completes the course, the marketing partner will receive a direct financial benefit, as it will be the recipient of a travel reservation from that student. One benefit to the proprietor of the website is revenue from the sale of the SCUBA gear integrated with the course.

As the customer has already invested his or her time into the online course (this coursework is preferably non-transferable), the airline partner has a captive audience for its product. By providing an online SCUBA course 12 for free, the airline generates customer good-will and benefits from a value-added incentive useable in any outbound marketing. Accordingly, the marketing partner is likely to increase future leisure travel expenditures due to an increase in its customer base.

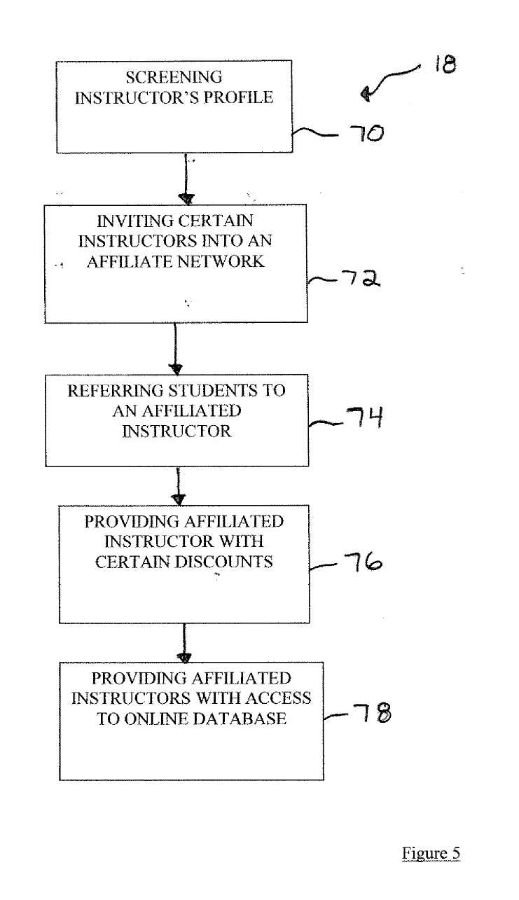

FIG. 5 illustrates a system and method for creating a virtual sales force 18. Currently, it is known that there are approximately 25,000 SCUBA instructors in the U.S. However, there are very few SCUBA instructors that can pursue this as a profession. This is in large part due to the abundant supply of instructors which results in lower prices being paid to these instructors for their services. Thus, SCUBA instructing is typically a hobby for most instructors. In accordance with the present invention, the proprietor will affiliate with SCUBA instructors such that they can work full time, which benefits both the instructors and the divers.

As shown, the virtual sales force 18 consists of SCUBA instructors that are affiliated with the proprietor of the online SCUBA instruction course 12. This provides multiple benefits including that students of the course are referred to a carefully selected and monitored group of affiliated SCUBA instructors. In accordance with this aspect, the profile of the instructors are screened, as generally indicated by reference number 70, to provide SCUBA instructors with the best qualifications for customers or students. The screening is preferably accomplished through the use of computerized questionnaires that are given to or obtained by interested instructors.

Once the instructors have been screened, certain instructors are selected based on their qualifications or other pertinent factors and invited to join an affiliated network of instructors, as generally indicated by reference number 72. Thereafter, as students complete their course and are arranging travel for their open dive certification with an instructor, the system 10 refers the students to an affiliated instructor in the affiliated network, as generally indicated by reference number 74. In one embodiment, the system and method 10 also conducts automated surveying of students to create a feedback mechanism that will assist future students in selecting their instructor. This is accomplished through the database 84.

The system also provides affiliated instructors with certain discounts and other benefits, as generally indicated by reference number 76, in order to attract the best possible instructors. These benefits include providing each affiliated instructor with a customized online store that automatically tracks the instructor's sales (merchandise of proprietor purchased by instructor's students) and generates passive income. Indeed, each affiliated instructor receives a commission on the sale of proprietor's merchandise to students. Further, each affiliated instructor receives special discounted pricing for certain dive equipment (for their own use as well as for student use) and dive travel packages. Each affiliated instructor also receives special discounted pricing on other merchandise of the proprietor. Each affiliated instructor also receives other benefits as will be understood by one of ordinary skill in the art.

Additionally, each of the affiliated instructors is provided access to the proprietor's online database 84, as generally indicated by reference number 78. This allows the affiliated instructors to communicate with other instructors in the affiliate network in a cost-effective manner. It also gives the instructors the ability to review a student's online coursework, including quiz and test answers. Additionally, it provides instructors with an online management tool to allow them to manage their availability for future bookings by students.

In accordance with the disclosed system and method, once the student has completed the SCUBA instruction course 12 and is ready to make arrangements for the open water dive certification, the system in accordance with one embodiment utilizes a collective reverse auction, as generally indicated by reference number 20, to make the necessary travel arrangements. In general, the collective reverse auction 20 works by having the website proprietor 90 encourage its large customer base to register its travel preferences in the database 84. Additionally, all students are required to enter their preferences into the database 84 by filling out the questionnaires as part of the online SCUBA course 12. These preferences include preferred destination, dates, room types, etc. The proprietor then assembles these individual preferences into “virtual groups” in order to collectively bargain with several alternative providers for both a better price for the traveler as well as the proprietor. Obviously, to the extent a student was referred to the course by a partner travel entity, that student will utilize the services of that travel partner.

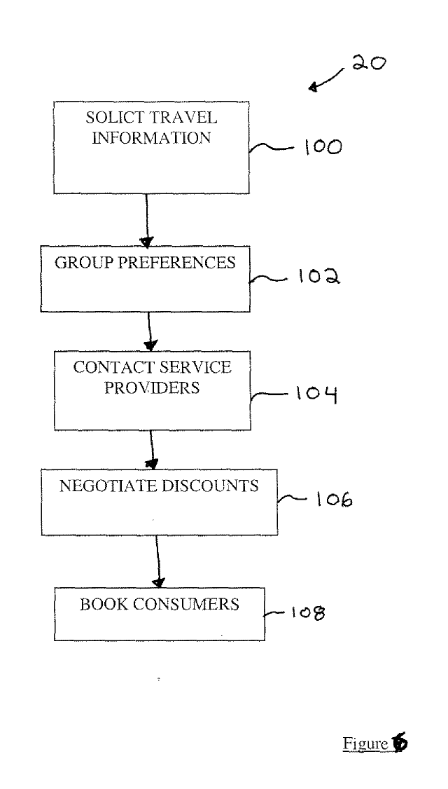

The complete details of the collective reverse action are disclosed in U.S. patent application Ser. No. 10/752,922, filed on Jan. 7, 2004, and entitled “System And Method For Arranging Group Travel”, which is hereby incorporated by reference. However, FIG. 6 illustrates broadly the collective reverse action.

Specifically, the database 84 and the database processor 86 receive travel information from the plurality of consumers 80 and group this information into requirements and preferences including, for example, “individuals interested in the same trip.” Once a certain number of students who are ready for travel meet a selected criterion, they are contacted and a trip is proposed to them. In an example, if one or more students have completed the course 12 and require a travel vacation for their certification and they share the same travel preferences, the database 84 will contact other divers with the same travel criteria to gather a larger group. The database processor 86 then contacts the plurality of service providers 80, negotiates group rates or group discounts on behalf of the plurality of consumers 80, confirms interest in booking, and books the plurality of consumers on the trip (e.g. a SCUBA trip) for the negotiated price.

Referring to FIG. 6, either a database operator or the database processor 86 receives consumer preference information in response to solicitations or consumer inquires, as generally indicated by reference number 100. In block 102, the database processor 86 groups consumers having common consumer preferences. In operation block 104, the database processor 86 operating the database 84 contacts several service providers. In operation block 106, the database processor 86 operating the database 84 negotiates a discount with at least one of the travel service providers. This discount is then either applied directly to the group or redirected to offset costs of other activities desired by members of the group, such as SCUBA related activities. Important to note is that the discounts may be on a group basis, for example, the database processor 86 will guarantee a number of spots for a high enough rate promised by the consumer 80.

In operation block 108, the database processor 86 operates the database 84 books the consumers into a vacation package. In operation, a method for arranging travel includes receiving travel information from a plurality of consumers, generating a grouping of consumers having common travel requirements as a subset of the plurality of consumers, contacting at least one service provider, and negotiating a group discount with the at least one service provider as a function of the grouping. The method further includes substituting a SCUBA related activity for cost savings associated with the group discount, generating an individualized SCUBA information profile for at least one member of the grouping of consumers, and booking the grouping with the at least one service provider.

It will be understood that each student's trip for dive certification could be booked individually as opposed to using the collective reverse action.

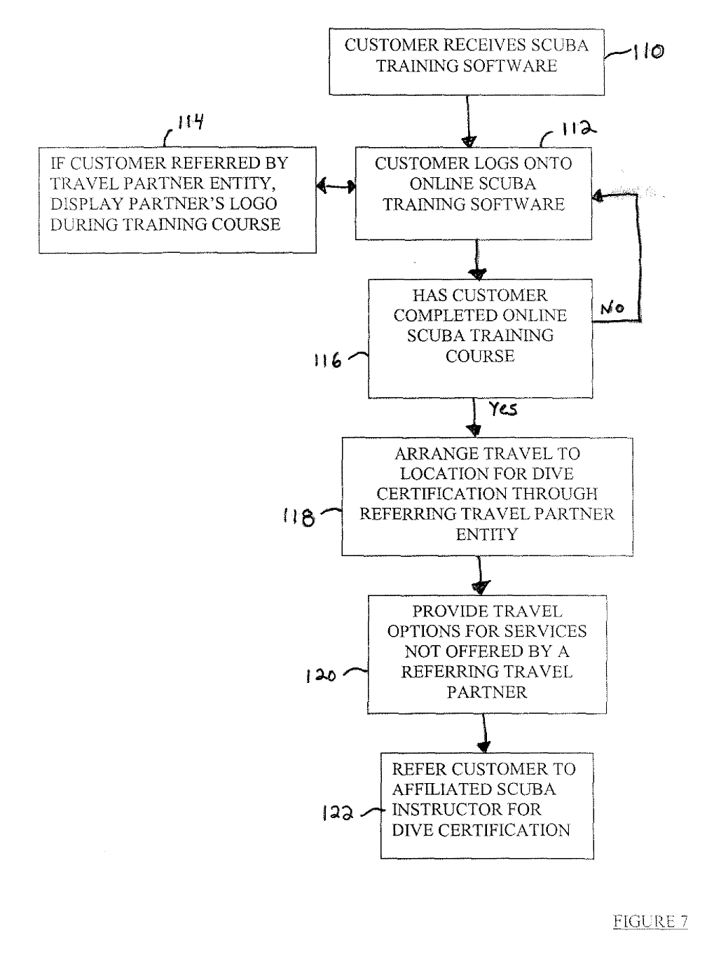

Referring now to FIG. 7, which illustrates an exemplary operation of the present system. First, as generally indicated by reference number 110, the customer receives access to the SCUBA training software 12 through some channel. In step 112, the student or customer logs onto the online SCUBA training course 12 by accessing the website on which the course 12 is maintained from a remote computer.

In accordance with one embodiment, the database 86 determines whether the student accessing the course 12 was referred by a marketing partner or whether the student acquired access to the course 12 by other means unrelated to any marketing partner. If the customer accesses the SCUBA course 12 from a referring partner, the course content is automatically modified to display the referring partner or partners brand and logo for the student as they progress through the course 12, as generally indicated by reference number 114. If the customer accesses the course through other means, the course content will remain generic.

The database 86 also monitors each student's progress throughout the course 12, as generally indicated by reference number 116. This in turn allows affiliated instructors to also monitor the customer's progress as well as review their test and quiz answers. When the student has completed the course 12, the system 10 arranges travel to a location, such as a tropical location, to allow the student to complete their open water dive and become certified. If the student was referred to the course 12 by one of the travel partners, the database 84 or the proprietor 90 communicates with that travel partner to book a portion of the travel reservation with it, as generally indicated by reference number 118.

At the same time, the database 84 or the proprietor 90 communicates with the non-referring travel partners in the integrated platform to arrange for the other travel accommodations not offered or satisfied by the referring travel partner, as generally indicated by reference number 120. This can be done individually for each student or in the form of a reverse collective auction as discussed above. The database 84 also refers the student or customer to an affiliated SCUBA instructor that their dive certification can be completed while on their vacation, as generally indicated by reference number 122.

From the foregoing, it can be seen that there has been brought to the art a new and improved system and method for making travel arrangements. It is to be understood that the preceding description of the preferred embodiment is merely illustrative of some of the many preferred embodiments that represent applications of the principals of the present invention. Numerous and other arrangements would be evident to those skilled in the art without departing from the scope of the invention as defined by the following claims.

What is claimed is:

1. A method for integrating the delivery of an online SCUBA course with other online services, comprising:
providing an online SCUBA instruction course;
forming a marketing partnership between at least one partner travel entity that offers services relevant to SCUBA diving and a proprietor of said online SCUBA instruction course;
allowing said at least one partner travel entity to distribute links in marketing efforts to allow a plurality of potential customers to access said online SCUBA instruction course at no charge;
monitoring the progress of at least one of said plurality of potential customers through said online SCUBA instruction course;
booking an in-water dive for said at least one of said plurality of customers utilizing said services of said at least one partner travel entity.

2. The method of claim 1, wherein said at least one partner travel entity is an airline.

3. The method of claim 2, further comprising:
limiting airline options for booking said in-water dive to said partner airline.

4. The method of claim 1, further comprising:
creating a virtual sales force consisting of SCUBA instructors that are affiliated with said proprietor and to whom said at least one of said plurality of customers can be referred.

5. The method of claim 1, further comprising:
customizing said online SCUBA instruction course to display a brand and logo of said partner travel entity.

6. A method of allowing students to become easily certified for SCUBA diving, comprising:
providing access to an online SCUBA course that allows a student to complete said online SCUBA course conveniently;
forming a plurality of marketing partnerships with travel entities to assist in distributing links to said online SCUBA course to customers and potential customers of said travel entities;
creating affiliations with a plurality of qualified SCUBA instructors;
booking travel for said student to complete said in-water dive through said travel entities; and
assigning said student to one of said plurality of qualified SCUBA instructors to complete said certification.

7. The method of claim 6, further comprising:
monitoring the progress of said student through said online SCUBA instruction course.

8. The method of claim 6, wherein said at least one travel entity is an airline.

9. The method of claim 8, further comprising:
limiting airline options for booking said in-water dive to said partner airline.

10. The method of claim 1, further comprising:
customizing said online SCUBA instruction course to display a brand and logo of said travel entity.
